(19) United States
(12) Patent Application Publication
(10) Pub. No.: US 2002/0078095 A1
(43) Pub. Date: Jun. 20, 2002

(54) Method of linking web pages

(76) Inventor: Earl Alexander Culham, Edmonton (CA)

Correspondence Address: DAVIS & BUJOLD, P.L.L.C., 500 NORTH COMMERCIAL STREET, FOURTH FLOOR, MANCHESTER, NH, 03101, US

(21) Appl. No.: 09/988,689

(22) Filed: Nov. 20, 2001

(30) Foreign Application Priority Data
Nov. 22, 2000 (CA) 2,327,011

(51) Int. Cl. G06F 15/00

(52) U.S. Cl. 707/516

(57) ABSTRACT

A method of linking web pages involving a step of associating one or more supplementary links with a primary web page. The one or more supplementary links are selectively accessible to the user to enable the user to access one or more secondary web pages. The described method allows multiple supplementary links to be associated with every point on a web page, so that each web page can potentially have thousands of supplementary links.

### FIELD OF THE INVENTION

The present invention relates to a method of linking web pages on the World Wide Web.

### BACKGROUND OF THE INVENTION

The form of “link” most commonly used on the world wide web is a hypertext link, also known as a “uniform resource locator” or “URL”. With a hypertext link, the content provider is in control of the linking, as the link is embedded in the text of the content provided by the content provider. The content provider specifies where on the page the hypertext link will be active and to what page the hypertext link will link. The user follows the hypertext link by clicking on the active area. When the content provider adds a link, care must be taken as additional content will change the alignment of the page.

### SUMMARY OF THE INVENTION

The present invention relates to an alternative form of linking web pages.

According to the present invention there is provided a method of linking web pages which involves a step of associating one or more supplementary links with a primary web page. Means is provided by which the one or more supplementary hidden links becomes accessible to the user to enable the user to access one or more secondary web pages.

With the supplementary links, as described above, control over the addition of links is no longer the exclusive domain of the content provider. There will hereinafter be described a number of ways that supplementary links can be added. Depending upon the manner of adding the supplementary links, further advantages can be obtained.

Although beneficial results may be obtained through the use of the method of linking web pages, as described above, in the past there has always been a one to one relationship between an HTML tag and a link. As more HTML tags were added the additional content changed the alignment of the page and eventually overflowed the page. Even more beneficial results may, therefore, be obtained when the one or more supplementary links are stored in a datastructure that is separate from the primary web page. By associating the datastructure with the primary web page, numerous supplementary links may be associated with the primary web page.

There are various means by which the one or more supplementary links can become accessible to the user. One approach is to have the supplementary links hidden until accessed through a user initiated command. The user initiated command could be given through a single HTML tag on the primary web page. The user initiated command could be given through a keystroke command code. The user initiated command could be given through an icon either on the primary web page or as part of the browser program.

An alternative approach, would be to provide a browser search option which automatically makes the supplementary links accessible to the user immediately upon the user accessing the primary web page.

It is anticipated that the implementation of supplementary links will lead to dynamic growth in linking. To facilitate that dynamic growth it is preferred that the website include a request for linking application process whereby a third party seeks permission from an owner of the primary web page to add a new supplementary link to the primary web page. It is envisaged that for most requests the approval process can be automated. Even more beneficial results may, therefore, be obtained when the request for linking application process preferably includes a list of criterion which must be met before the third party can add a new supplementary link to the primary web page. The addition of the new supplementary link is automatically permitted upon the third party meeting the list of criterion.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is block diagram of a first embodiment of the method of linking web pages on the World Wide Web through an associated datastructure in accordance with the teachings of the present invention by the addition of a single HTML tag to the content of the web page.

FIG. 2 is front elevation view of a screen output visible to a user in accordance with the first embodiment of the method illustrated in FIG. 1.

FIG. 3 is a block diagram of a second embodiment of the method of linking web pages on the world wide web through an associated datastructure in accordance with the teachings of the present invention, through an association that does not add any content to the web page.

FIG. 4 is a front elevation view of a screen output visible to a user in accordance with the second embodiment, providing a browser command to view hidden supplementary links.

FIG. 5 is a front elevation view of a screen output visible to a user in accordance with the second embodiment, providing an icon on the tool bar of the browser to view hidden supplementary links.

FIG. 6 is a block diagram of a third embodiment of the method of linking web pages on the world wide web in accordance with the teachings of the present invention, in which the supplementary links are hidden on the primary web page.

FIG. 7 is a front elevation view of a screen output normally visible to a user in accordance with the third embodiment.

FIG. 8 is a front elevation view of a screen output visible to a user in accordance with the third embodiment, when the hidden supplementary links are made visible through user access commands.

FIG. 9 is a front elevation view of a screen output visible to a user in accordance with the third embodiment, through the use of an X-ray cursor.

FIG. 10 is a simplified flow diagram of processing logic for linking requests.

FIG. 11 is a flow diagram of processing logic reflecting the input of the various parties having an interest in the linking request.

FIG. 12 is a front elevation view of a computer screen illustrating a hidden supplementary links search strategy.

FIG. 13 is a front elevation view of a computer screen illustrating search criterion for hidden supplementary links.

### DETAILED DESCRIPTION OF THE PREFERRED EMBODIMENT

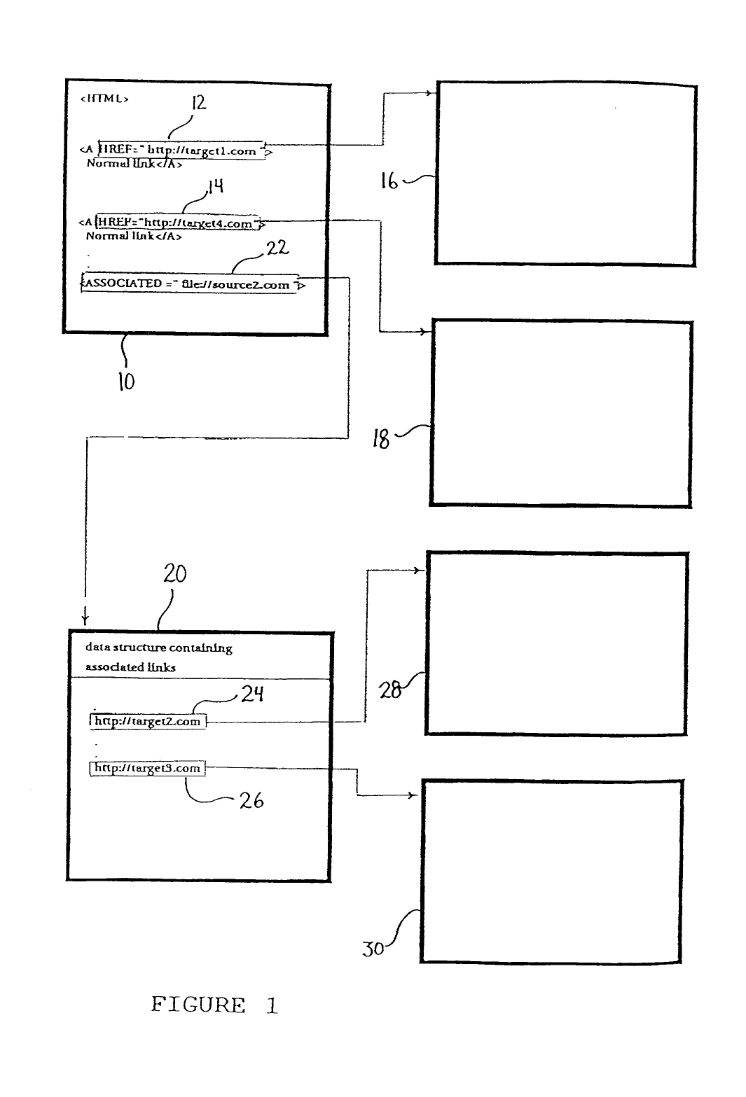

The preferred method of linking web pages on the World Wide Web will now be described with reference to FIGS. 1 through 13.

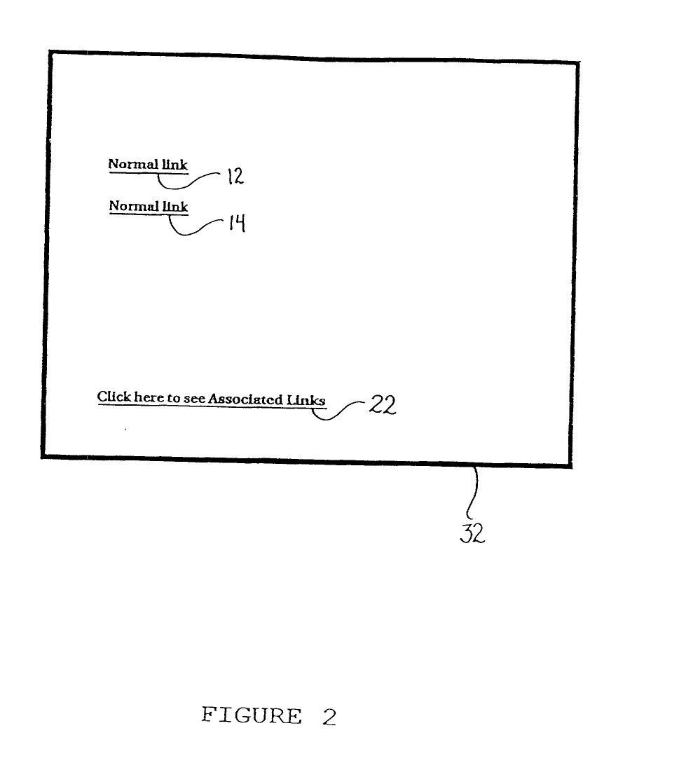

Referring to FIG. 1, there is illustrated an existing web page 10 that contains several “normal” HTML links 12 and 14 that are linked to secondary web pages 16 and 18, respectively. In accordance with the teachings of the present invention existing web page 10 has been associated with a datastructure 20 by adding to existing web page 10 of a single additional HTML tag 22. Datastructure 20 contains supplementary links. Two supplementary links 24 and 26 are shown for the purpose of illustration, but there can be dozens, hundreds or thousands of such supplementary links. Supplementary links 24 and 26 are, in turn, linked to secondary web pages 28 and 30. Referring to FIG. 2, a computer screen 32 is illustrated and additional HTML tag 22 is shown as being visible to the user as part of existing web page 10, as is the content of existing web page 10 along with normal links 12 and 14.

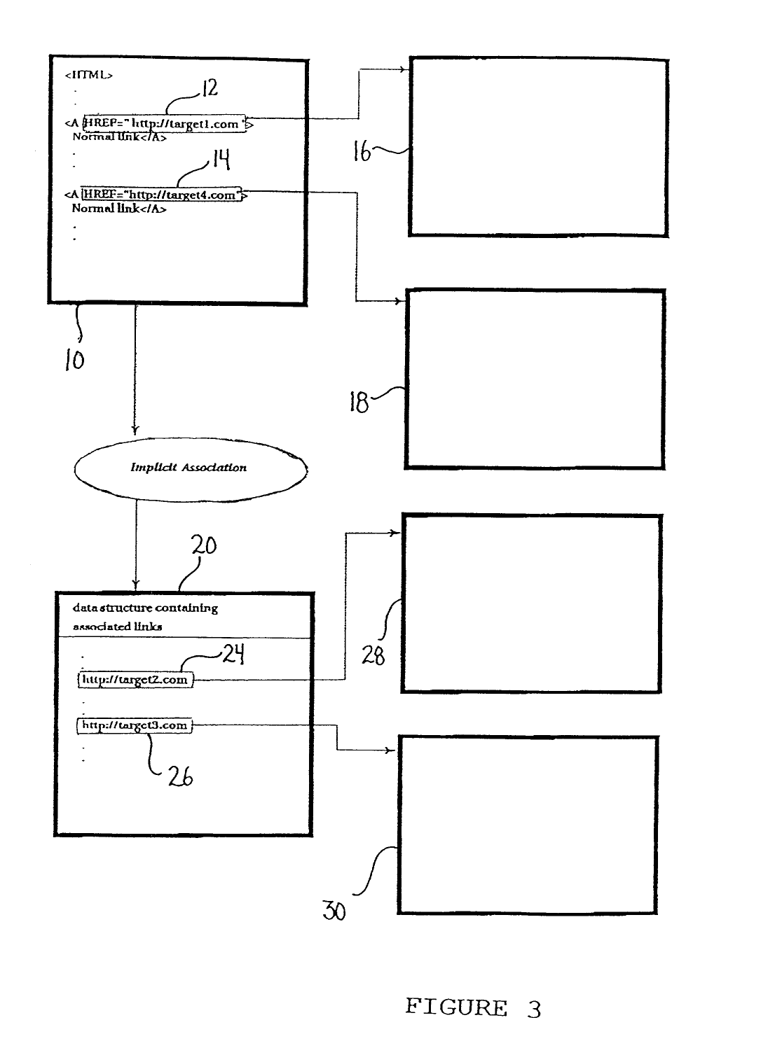

Referring to FIG. 3, there is illustrated existing web page 10, as in FIG. 1. In FIG. 3, however, instead of adding single additional HTML tag 22 to existing web page 10 the association is created without adding to the content of existing web page 10. In all other respects, the embodiment illustrated in FIG. 3, is identical to that illustrated in FIG. 1. There are a number of ways in which this association could be established. One way is for links 24 and 26 to be placed in a shared data structure, and the name of existing web page 10 used as an index to find links 24 and 26 within that data structure. Another way is for links 24 and 26 to be placed in a file in a parallel file system. For example, if existing web page 10 was held in a file called:

“/U01/existing-web-page”

links 24 and 26 could be held in a file called:

“/a-links/existing-web-page”.

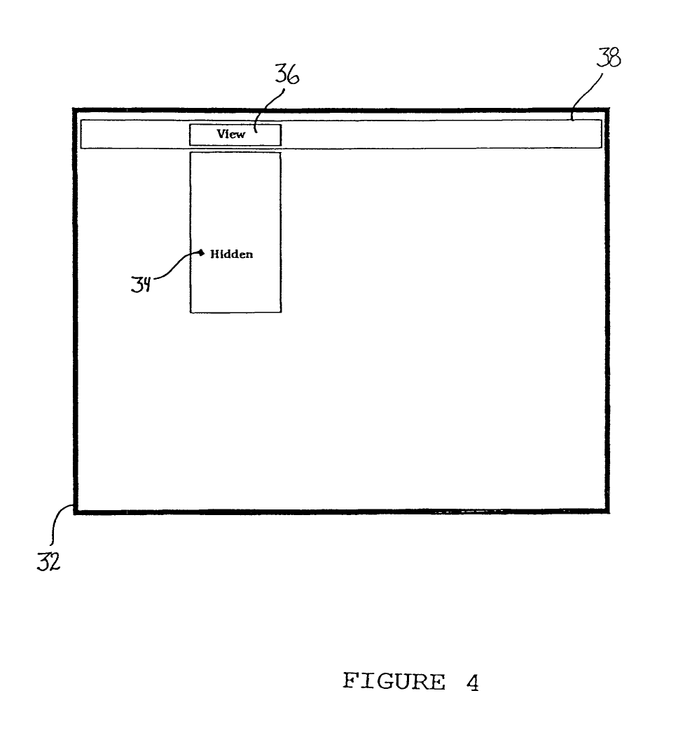

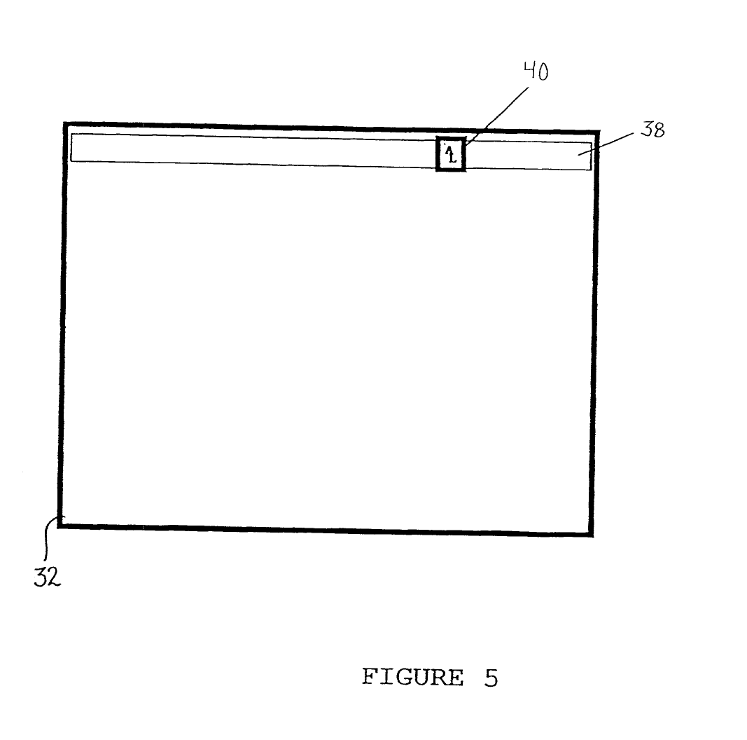

Access to links 24 and 26 of datastructure 20, can either occur immediately upon the user accessing existing web page 10 or can occur upon demand by user initiated commands. There are numerous key stroke commands that can be input by the user through the keyboard alone or through a combination of keyboard and mouse input. These can not be graphically illustrated, but one example of such a command might be depressing the <ALT> key on the keyboard and then clicking on the mouse for an <ALT> CLICK command. Other user initiated commands can be illustrated. Referring to FIG. 4, there is illustrated how a command 34 to seek out hidden supplementary links could be placed under VIEW 36 on a browser tool bar 38. Referring to FIG. 5, there is illustrated how an icon 40 representing a “seek out hidden supplementary links” command could be positioned on browser tool bar 38.

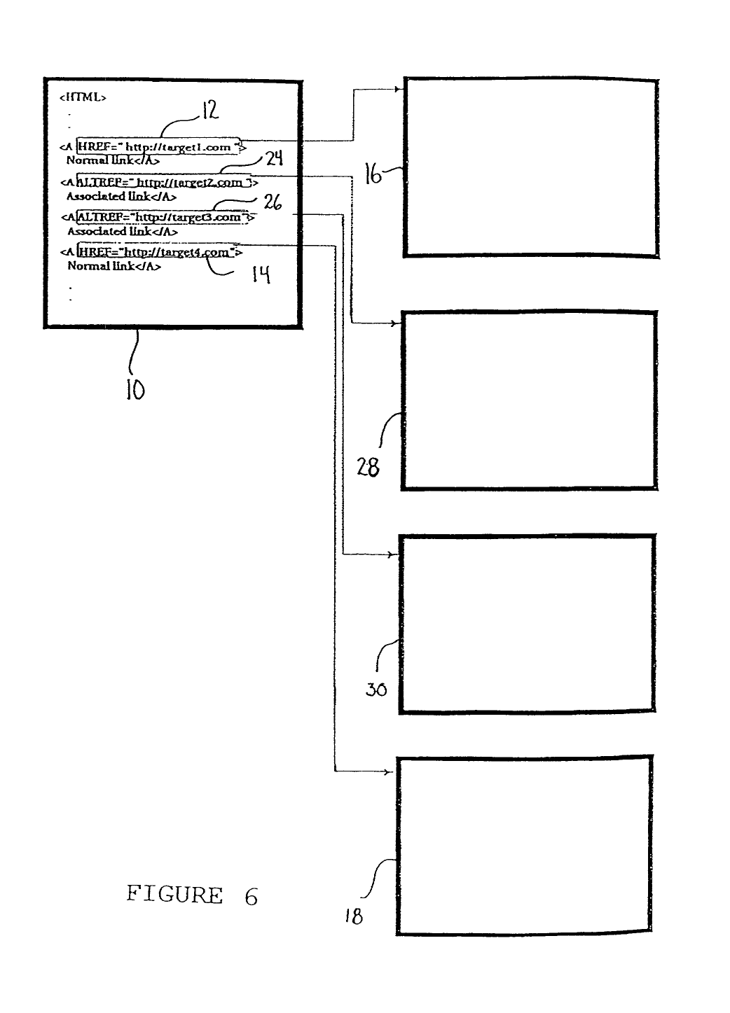

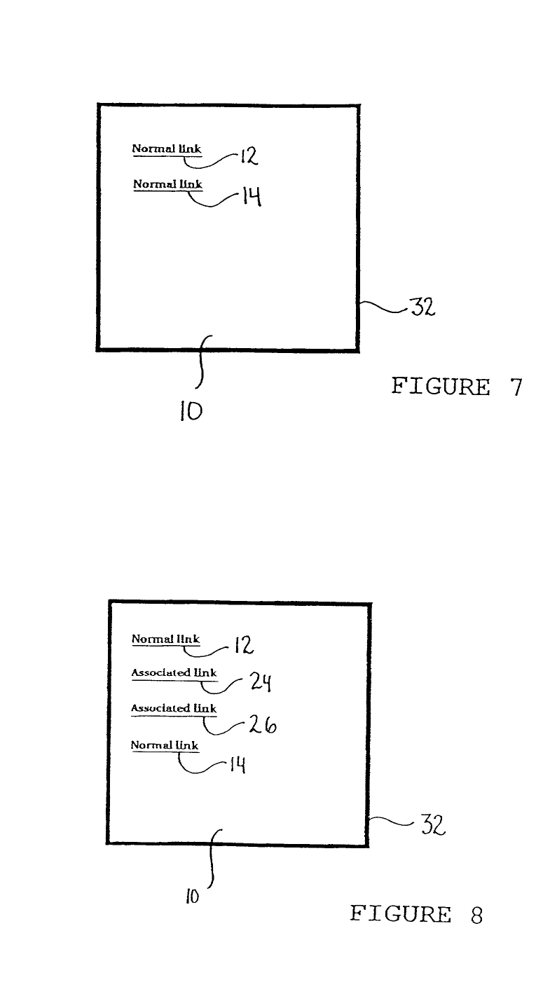

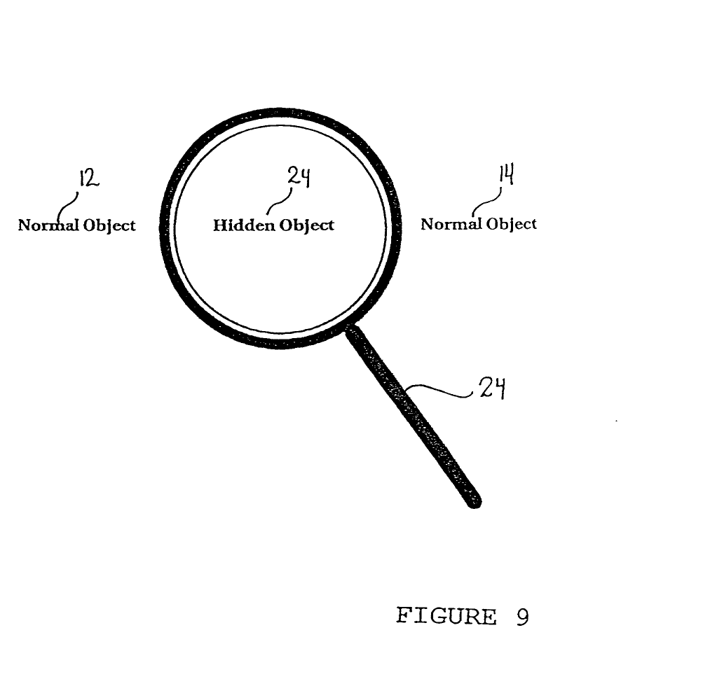

Referring to FIG. 6, it is also possible to implement an inferior version of the present invention without resorting to a separate datastructure 20. In accordance with this aspect of the invention hidden supplementary links 24 and 26 are added directly onto existing web page 10. This version has been referred to as “inferior” as it would not be practical to add hundreds of links using this approach. Referring to FIG. 7, when the user viewed existing web page 10 only normal links 12 and 14 would be visible on computer screen 32. Referring to FIG. 8, there is illustrated the change in what a user would see on computer screen 32 once a user initiated command was given. It will be noted that hidden supplementary links 24 and 26 become visible, in addition to normal links 12 and 14. Referring to FIG. 9, there is illustrated how the same hidden supplementary links 24 could alternatively be seen using an “x-ray” style of cursor 42.

This x-ray cursor helps to graphically demonstrate how supplementary links can be linked to any point or pixel on a web page. Of course, since there are multiple points or pixels on each web page, there can be multiple hidden links. It may be more difficult to conceptually grasp that there can also be multiple supplementary links linked to any point or pixel on a web page. These supplementary links remain hidden until an user initiated command is given, such as <ALT> CLICK. In this way thousands of supplementary links can be associated with each web page.

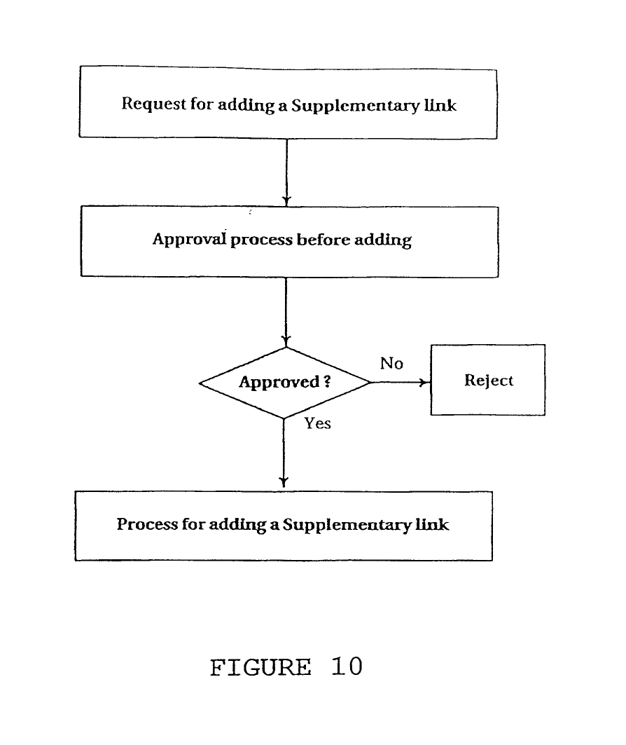

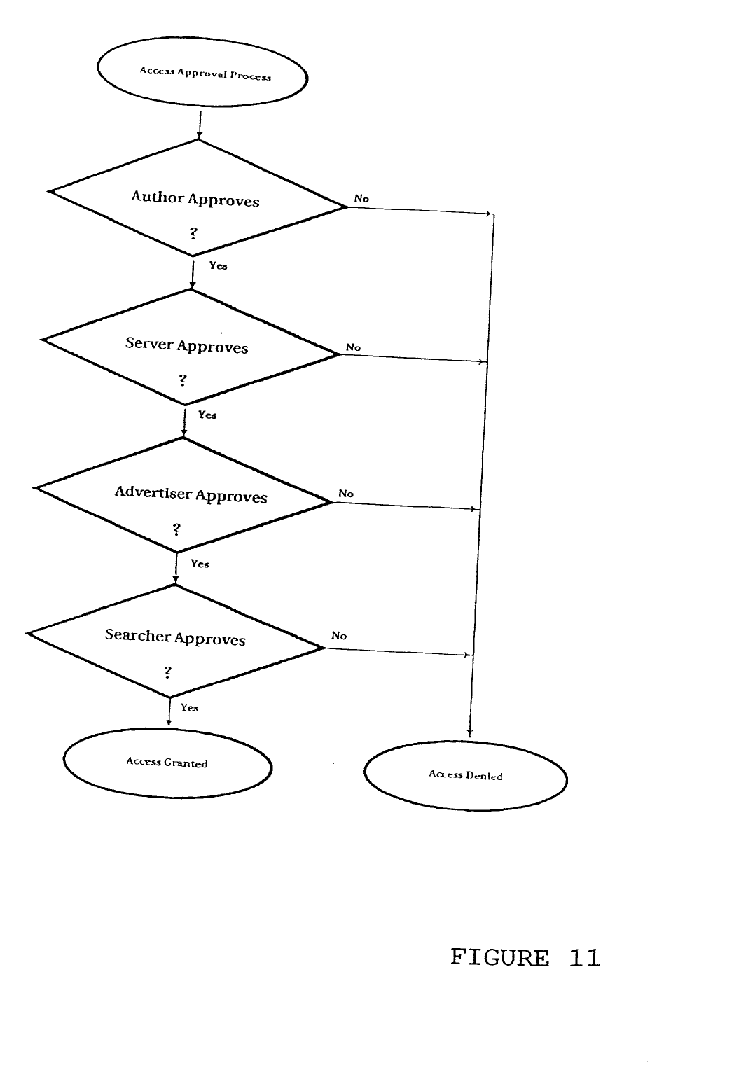

Referring to FIG. 10, the processing logic for LINKING REQUESTS is illustrated. The information on the request for linking form is compared with a list of criterion which must be met before a third party can add a new link to the datastructure for association with existing web page 10. If the criterion is met the system permits the addition of the new link, without human intervention. If the criterion is not met the request for linking is rejected.

Referring to FIG. 11, there is illustrated how the access approval process can be expanded so that the criterion of the author, the server, and key advertisers must be met before linking is approved. The searcher making the linking request has the final say as to whether he or she is prepared to meet the criterion of the parties, which may include the payment of monies.

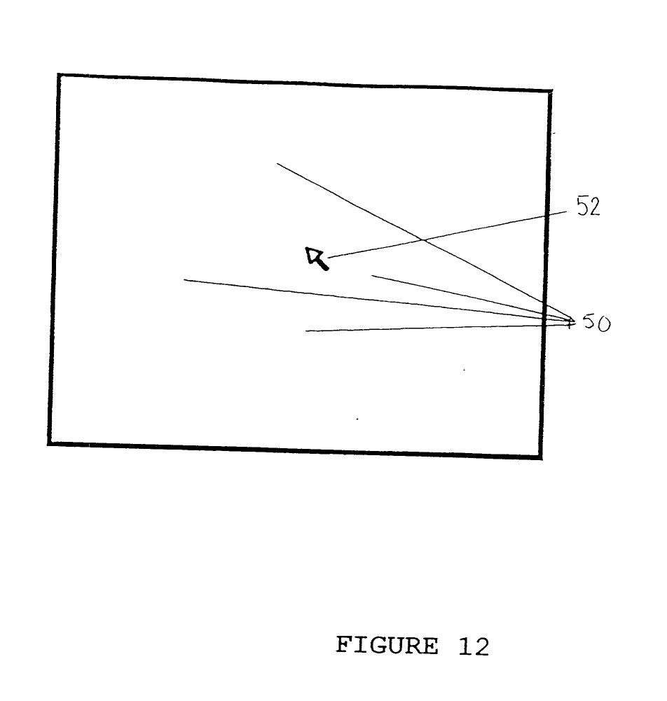

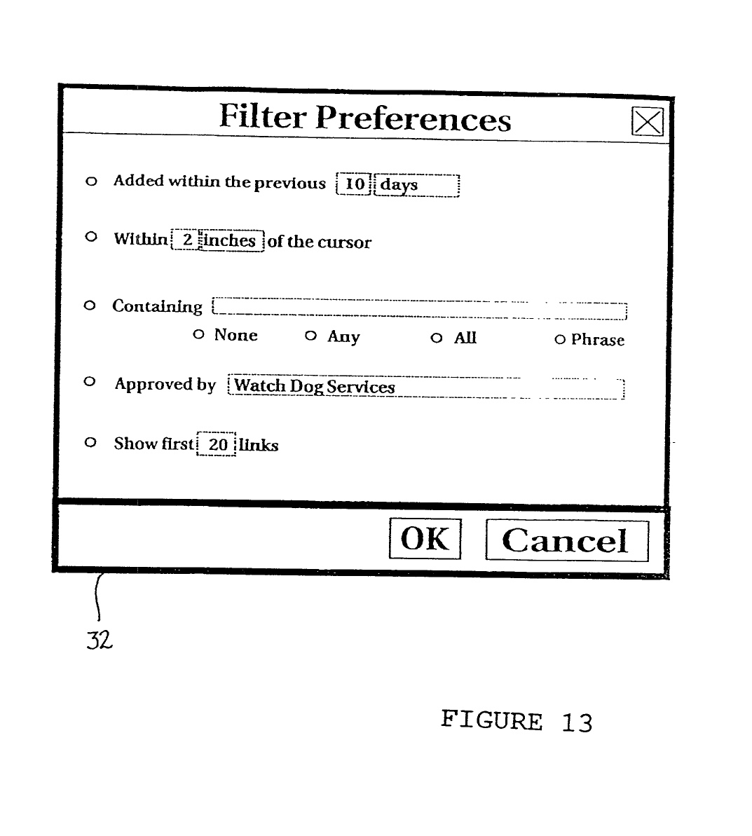

Once supplementary links come into common usage, it is envisaged that some popular websites will have hundreds of supplementary links. This may result in a need to search for only those supplementary links that are desired. Referring to FIG. 12, it may be desirable to have the capability to search for all hidden supplementary links 50 which are within a specified proximity to cursor 52. Referring to FIG. 13, there may be other criterion that are desirable to search through the hidden supplementary links selecting only those with the specified criterion. As illustrated in FIG. 13, the criterion may include:

selection of the hidden supplementary links by date;

selection of the hidden supplementary links by distance from the cursor;

selection based upon the presence or absence of a word or phrase, as is common with boolean key word searching; and

selection based upon third party approval.

The number of links listed in the search results could, if desired, be limited to a specified number.

Of course, once this teaching is known, the search capabilities can be expanded to add other search criterion.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the Claims.

The embodiments of the invention in which an exclusive property or privilege is claimed are defined as follows:

1. A method of linking web pages, comprising the step of:
associating at least one supplementary link with a primary web page;
providing means by which the at least one supplementary link becomes accessible to the user to enable the user to access at least one secondary web page.

2. The method as defined in claim 1, the at least one supplementary link being stored in a datastructure that is separate from the primary web page.

3. The method as defined in claim 2, the datastructure being associated with the primary web page.

4. The method as defined in claim 1, the at least one supplementary link is hidden and becomes accessible to the user through a user initiated command.

5. The method as defined in claim 4, the user initiated command being given through a single HTML tag on the primary web page.

6. The method as defined in claim 4, the user initiated command being a keystroke command code.

7. The method as defined in claim 4, the user initiated command being through an icon.

8. The method as defined in claim 1, the means by which the at least one supplementary link becomes accessible to the user is a browser search option which automatically makes the at least one supplementary link accessible to the user immediately upon the user accessing the primary web page.

9. The method as defined in claim 7, the icon being on a browser's tool bar.

10. The method as defined in claim 1, including a request for linking application process whereby a third party seeks permission from an owner of the primary web page to add a new supplementary link to the primary web page.

11. The method as defined in claim 10, the request for linking application process including a list of criterion which must be met before the third party can add a new supplementary link to the primary web page, the addition of the new supplementary link being automatically permitted upon the third party meeting the list of criterion.

12. The method as defined in claim 1 or 4, further including means for searching for supplementary links within a specified proximity to a cursor.

13. The method as defined in claim 1 or 4, further including a search engine that searches for supplementary links that meet specified search criterion.

14. A method of linking web pages, comprising the step of:
associating at least one supplementary link with a primary web page, the at least one supplementary link being stored in a datastructure that is separate from content of the primary web page, the at least one supplementary link providing access to at least one secondary web page.

15. The method as defined in claim 14, the at least one supplementary link being hidden to a user when the primary web page is active, until selectively accessed by a user.

16. The method as defined in claim 14, the datastructure containing several supplementary links associated with the primary web page.

17. The method as defined in claim 15, the at least one supplementary hidden link becoming accessible to the user is through a user initiated command.

18. The method as defined in claim 17, the user initiated command being given through a single HTML tag on the primary web page.

19. The method as defined in claim 17, the user initiated command being a keystroke command code.

20. The method as defined in claim 17, the user initiated command being through an icon.

21. The method as defined in claim 17, the at least one supplementary hidden link becomes accessible to the user is a browser search option which automatically makes the at least one hidden link accessible to the user immediately upon the user accessing the primary web page.

22. The method as defined in claim 20, the icon being on a browser's tool bar.

23. The method as defined in claim 14 including a request for linking application process whereby a third party seeks permission from an owner of the primary web page to add a new supplementary link to the primary web page.

24. The method as defined in claim 23, the request for linking application process including a list of criterion which must be met before the third party can add a new supplementary link to the primary web page, the addition of the new supplementary link being automatically permitted upon the third party meeting the list of criterion.

25. The method as defined in claim 14, further including means for searching for hidden supplementary links within a specified proximity to a cursor.

26. The method as defined in claim 14, further including a search engine that searches for hidden supplementary links that meet specified search criterion.

27. A method of linking web pages, comprising the step of:
providing a primary web page with a request for linking application process whereby a third party seeks permission from an owner of the primary web page to add a new link to the primary web page.

28. The method as defined in claim 27, the request for linking application process including a list of criterion which must be met before the third party can add a new link to the primary web page, the addition of the new link being automatically permitted upon the third party meeting the list of criterion.

29. A method of linking web pages, comprising the step of:
associating several supplementary hidden links with a primary web page, the supplementary hidden links being stored in a datastructure that is separate from content of the primary web page;
providing a user initiated command by means of which the supplementary hidden links becomes accessible to the user to enable the user to access selected secondary web pages.
providing a request for linking application process whereby a third party seeks permission from an owner of the primary web page to add a new supplementary hidden link to the primary web page, the request for linking application process including a list of criterion which must be met before the third party can add a new supplementary hidden link to the primary web page, the addition of the new supplementary hidden link being automatically permitted upon the third party meeting the list of criterion.

30. A web page link, comprising:
at least one supplementary hidden link associated with a primary web page; and
means by which the at least one supplementary hidden link becomes accessible to the user to enable the user to access at least one secondary web page.

31. The web page link as defined in claim 30, wherein the at least one supplementary hidden link is stored in a datastructure that is separate from the primary web page.

32. The web page link as defined in claim 30, wherein the datastructure contains several supplementary hidden links associated with the primary web page.

33. The web page link as defined in claim 30, wherein the means by which the at least one supplementary hidden link becomes accessible to the user is through a user initiated command.

34. The web page link as defined in claim 33, wherein the user initiated command is given through a single HTML tag on the primary web page.

35. The web page link as defined in claim 33, wherein the user initiated command is a keystroke command code.

36. The web page link as defined in claim 33, wherein the user initiated command is through an icon.

37. The web page link as defined in claim 30, wherein the means by which the at least one hidden link becomes accessible to the user is a browser search option which automatically makes the at least one supplementary hidden link accessible to the user immediately upon the user accessing the primary web page.

38. The web page link as defined in claim 36, wherein the icon is on a browser's tool bar.

39. The web page link as defined in claim 30, wherein a request for linking application process is provided whereby a third party seeks permission from an owner of the primary web page to add a new supplementary hidden link to the primary web page.

40. The web page link as defined in claim 39, wherein the request for linking application process includes a list of criterion which must be met before the third party can add a new supplementary hidden link to the primary web page, the addition of the new supplementary hidden link being automatically permitted upon the third party meeting the list of criterion.

41. The web page link as defined in claim 30, wherein means are provided for searching for hidden supplementary links within a specified proximity to a cursor.

42. The web page link as defined in claim 30, wherein a search engine is provided that searches for hidden supplementary links that meet specified search criterion.

43. A web page link, comprising:
at least one supplementary link with a primary web page, the at least one supplementary link being stored in a datastructure that is separate from content of the primary web page, the at least one supplementary link providing access to at least one secondary web page.

44. The web page link as defined in claim 43, wherein the at least one supplementary link is hidden to a user when the primary web page is active, until selectively accessed by a user.

45. The web page link as defined in claim 43, wherein the datastructure contains several supplementary links associated with the primary web page.

46. The web page link as defined in claim 44, wherein the at least one supplementary hidden link becomes accessible to the user through a user initiated command.

47. The web page link as defined in claim 46, wherein the user initiated command is given through a single HTML tag on the primary web page.

48. The web page link as defined in claim 46, wherein the user initiated command is a keystroke command code.

49. The web page link as defined in claim 46, wherein the user initiated command is through an icon.

50. The web page link as defined in claim 43, wherein the at least one supplementary hidden link becomes accessible to the user as a browser search option which automatically makes the at least one hidden link accessible to the user immediately upon the user accessing the primary web page.

51. The web page link as defined in claim 49, the icon being on a browser's tool bar.

52. The web page link as defined in claim 43, wherein a request for linking application process is provided whereby a third party seeks permission from an owner of the primary web page to add a new supplementary link to the primary web page.

53. The web page link as defined in claim 43, wherein the request for linking application process includes a list of criterion which must be met before the third party can add a new supplementary link to the primary web page, the addition of the new supplementary link being automatically permitted upon the third party meeting the list of criterion.

54. A web page link, comprising:
a primary web page with a request for linking application process whereby a third party seeks permission from an owner of the primary web page to add a new link to the primary web page.

55. The web page link as defined in claim 54, wherein the request for linking application process includes a list of criterion which must be met before the third party can add a new link to the primary web page, the addition of the new link being automatically permitted upon the third party meeting the list of criterion.

56. A web page link, comprising:
several supplementary hidden links associated with a primary web page, the supplementary hidden links being stored in a datastructure that is separate from content of the primary web page;
a user initiated command by means of which the at supplementary hidden links becomes accessible to the user to enable the user to access selected secondary web pages;
a request for linking application process whereby a third party seeks permission from an owner of the primary web page to add a new supplementary hidden link to the primary web page, the request for linking application process including a list of criterion which must be met before the third party can add a new supplementary hidden link to the primary web page, the addition of the new supplementary hidden link being automatically permitted upon the third party meeting the list of criterion.

57. A web page link, comprising:
at least one supplementary link associated with a primary web page; and
means by which the at least one supplementary link becomes accessible to the user to enable the user to access at least one secondary web page.

58. The web page link as defined in claim 57, wherein the at least one supplementary link becomes accessible to the user through a user initiated command.

59. The web page link as defined in claim 58, wherein the user initiated command comprises one of a keystroke and pointer command.

60. The web page link as defined in claim 58, wherein the user initiated command is initiated through an X-ray cursor.

61. The web page link as defined in claim 58, wherein the at least one supplementary hidden link is embedded in an HTML file.

62. The web page link as defined in claim 58, wherein the association between the at least one supplementary link and the primary web page is explicitly reflected as content on the primary web page.

63. The web page link as defined in claim 58, wherein the association between the at least one supplementary link and the primary web page is implicitly derived from a selected attribute of the primary web page.

64. The web page link as defined in claim 58, wherein multiple supplementary links are provided with each supplementary link being linked to a point on the primary web page.

65. The web page link as defined in claim 58, wherein multiple supplementary are linked to individual points on the primary web page.

66. The method as defined in claim 1 or 4, the association between the at least one supplementary link and the primary web page being explicitly reflected as content on the primary web page.

67. The method as defined in claim 1 or 4, the association between the at least one supplementary link and the primary web page being implicitly derived from a selected attribute of the primary web page.

68. The method as defined in claim 1 or 4, having multiple supplementary links, with each supplementary link being linked to a point on the primary web page.

69. The method as defined in claim 1 or 4, multiple supplementary links being linked to individual points on the primary web page.
